(19) United States
(12) Patent Application Publication
(10) Pub. No.: US 2005/0255816 A1
(43) Pub. Date: Nov. 17, 2005

(54) Method of receiving signals in a spread-spectrum telecommunications system with terrestrial repeaters, comprising a complementary source

(76) Inventors: Michel-Guy Francon, Toulouse (FR); Nicolas Chuberre, Pibrac (FR); Steven Bouchired, Tournefeuille (FR); Christophe Nussli, Toulouse (FR)

Correspondence Address: SUGHRUE MION, PLLC, 2100 PENNSYLVANIA AVENUE, N.W., SUITE 800, WASHINGTON, DC, 20037, US

(21) Appl. No.: 10/529,914

(22) PCT Filed: Oct. 1, 2003
(86) PCT No.: PCT/FR03/02877

§ 371 Date: Jul. 14, 2005

(30) Foreign Application Priority Data
Oct. 3, 2002 (FR) 02/12241

(51) Int. Cl. H04B 17/02

(52) U.S. Cl. 455/137

(57) ABSTRACT

A method of receiving signals in a spread-spectrum telecommunications system with terrestrial repeaters, and a terminal for receiving, the terminal including two rake receivers (16, 18), each receiver having a set of demodulation channels (20-1, 20-n, 24-1, 24-n) and a combiner (22, 26). A third combiner (28) receives the signals provided by the combiners belonging to the two above-mentioned receivers. In this way, signals arriving from a diffuse system of terrestrial receivers and a complementary source can be received, in spite of the time differences between the different paths of the signals. The terminal can be used in a telecommunications system with numerous multiple paths.

The present invention relates to telecommunication systems, to be more precise to wideband code division multiple access (W-CDMA) telecommunication systems.

The code division multiple access (CDMA) technique is based on the principle of spreading the signals to be transmitted by means of one or more codes reserved to a call. The codes consist of a set of “chips” whose duration is very much less than the duration of an individual information element to be transmitted. The codes are orthogonal so that each user receives the signals that are intended for him as a result of despreading using the code or codes assigned to him. The CDMA principle is described in “CDMA: Principles of Spread Spectrum Communication” (Addison-Wesley Wireless Communications), by A. J. Viterbi, published by Prentice Hall PTR; ISBN: 0201633744, 1st edition—June 1995.

One of the problems encountered with the CDMA technique is that of multiple paths caused by reflections from obstacles such as buildings, for example. The result of these multiple paths is that a terminal or user equipment receives different copies of the signal intended for it, shifted in time. Because of the shift, the copies may interfere destructively, which weakens the signal. The problem is well known and one proposed prior art solution to it is to use rake receivers, which are described in the section of WO-A-01 47133 relating to the prior art, in WO-A-00 25439, and in EP-A-1 154 584, for example. A rake receiver is formed of a set of demodulation channels and a combiner; the information supplied by each channel is assigned a respective time-delay before the information is combined to optimize identification of the signal. In this context, a demodulation channel is referred to as a “finger”. A rake receiver uses the same despreading code for all the fingers.

The CDMAx baseband processor for third-generation terminals sold by Sirius Communications is intended for use in telecommunication systems of the type defined by the Universal Mobile Telecommunication System (UMTS) standards. This particular baseband processor comprises two rake receivers; the first receiver is used to receive the signal in a cell and the second receiver is used, near the boundary of the cell, to receive the signal coming from the adjacent cell. In this case, the first receiver operates with a first spreading code applied to all its fingers and the second receiver operates with a second spreading code, different from the first, on different channels. This use of two receivers enables the terminal to go from one cell to the other without interrupting the call; the corresponding intercellular transfer technique is known as “hand-off”. Each receiver described in the above document has eight fingers; the demodulator of a finger is able to demodulate six physical channels and to apply a time-delay of up to forty chips, which means typically a maximum time shift of 10 μs. This maximum time shift between the signals received on the various fingers or channels of the rake receiver is called the recombination window.

Another problem encountered in telecommunication systems is that of increases in traffic and in demand for bandwidth. To respond to these increases, it has been proposed to combine terrestrial repeaters with satellite or high-altitude platform system (HAPS) transmission. The term “high-altitude platform system” is defined in the specification Asia-Pacific Telecommunity Standardization Program (ASTAP) of the Expert Group on HAPS. HAPS are unmanned aircraft carrying out geostationary flights of long duration in the stratosphere at an altitude of approximately 20 km. The term “high altitude” refers to altitudes from 20 to 30 km. This adds a selective broadcast distribution layer to the point-to-point connections of conventional telecommunication networks; in terms of sources, the telecommunication network has terrestrial repeaters and a complementary source. This solution is proposed in particular in the Satellite Digital Multimedia Broadcast (S-DMB) system, which envisages using a component broadcast by a geostationary satellite with repeaters for urban and suburban areas; this allows some point-to-multipoint traffic to be transmitted direct to users. The satellite component uses the IMT2000 extended frequency band allocated to mobile satellite systems (MSS) and the terrestrial W-CDMA wavelength standardized by the Third Generation Partnership Project (3GPP). These choices allow optimum use of UMTS technologies for user equipment.

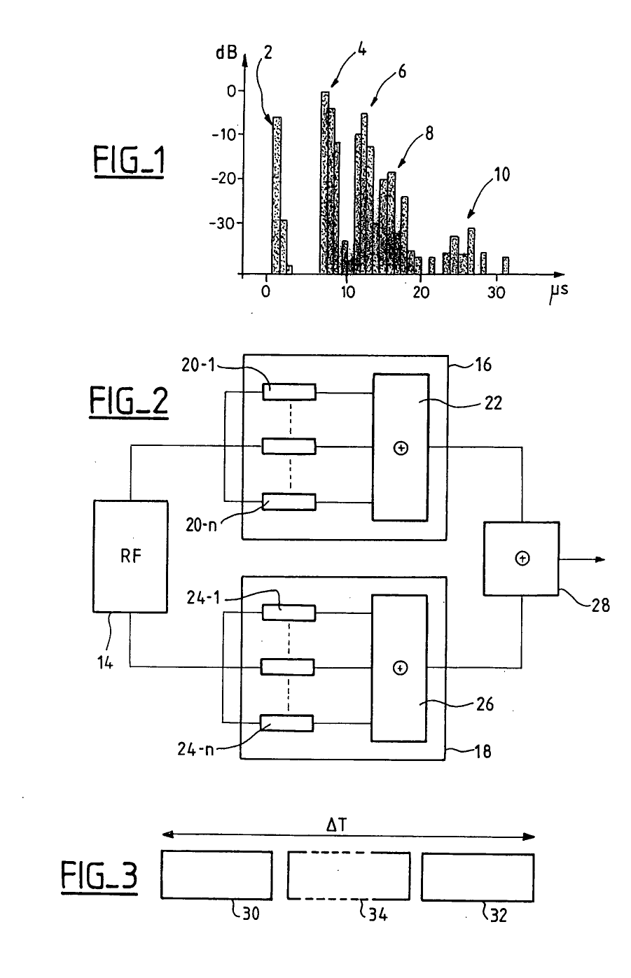

However, because of the repeaters and multiple paths, these solutions could lead to an increase in the number of copies of the signals received. FIG. 1 shows an example of the signal that might be received in a configuration with a satellite or a high-altitude platform broadcast system and terrestrial repeaters. The time shift between the various copies of the signal relative to the signal received directly from the satellite is plotted on the abscissa axis, which is graduated in microseconds. The relative receive level in dB is plotted on the ordinate axis. The figure shows the signal 2 received directly from the satellite or the high-altitude platform, at a level of the order of −7 dB. The figure also shows copies 4, 6, 8 and 10 of the signal received on multiple paths or from repeaters, with a time shift. The figure shows the background noise caused in particular by broadcasting. The figure shows that the time span over which copies of the signals are received can be as much as 27 μs, and that the signal levels range from approximately −5 dB to approximately −30 dB.

The problem of recombination window size therefore arises; the problem is described above in the example of a telecommunication system with a satellite broadcast layer, but arises generally whenever the number of copies of the signals received increases, even in the case of purely terrestrial systems. It would be beneficial to be able to provide a solution to this problem of recombination window size using existing technologies as much as possible.

WO-A-01 47133 proposes a method of receiving spread spectrum signals. A rake receiver has two antennas, the signals from which are time shifted by at least the duration of a chip and combined before being applied to the fingers of the receiver. This solution provides the advantages of antenna diversity without the signals from the two antennas interfering with each other. The document describes one possible structure of the rake receivers.

WO-A-00 25439 also relates to rake receivers; its objective is to enable simultaneous demodulation of signals having the shortest possible arrival time differences. It proposes to use only one symbol accumulator, on the downstream side of the combiner. This solution would reduce the complexity of the hardware and software compared to a solution in which each finger of the receiver has an accumulator.

EP-A-1 154 584 proposes to group the channels of a rake receiver into two “baskets”; one or more tracking mechanisms is (are) used for each basket. This technique is applied to the fingers of the receiver before any combination of the signals.

Other receivers are described in U.S. Pat. No. 6,381,229, U.S. Pat. No. 5,867,527, US-A-2002/0006158 and DE-A-199 37 247.

Consequently, one embodiment of the invention proposes a receiver for a spread-spectrum telecommunication system, the receiver including:
a first receiver with at least two demodulation channels and a first combiner receiving the demodulated signals supplied by the demodulation channels;
a second receiver with at least two demodulation channels and a second combiner receiving the demodulated signals supplied by the demodulation channels and
a third combiner receiving the signals supplied by the first and second combiners.

In one embodiment the time difference between the recombination window of the first receiver and the recombination window of the second receiver is greater than 30 μs. In one embodiment the recombination window of the first receiver and the recombination window of the second receiver cover a time span of at least 50 μs.

The invention also proposes a telecommunication system including:
terrestrial repeaters and a complementary source;
a receiver of the above kind.

The invention finally proposes a method of receiving signals coded by spectrum spreading in a telecommunication system including terrestrial repeaters and a complementary source, the method including:
providing a terminal with a first rake receiver and a second rake receiver;
receiving at least signals coming directly from the complementary source by means of the first rake receiver; and
receiving signals coming from at least one terrestrial repeater using the second rake receiver.
reception by means of the first rake receiver and reception by means of the second rake receiver are advantageously effected by despreading using the same code.

The method may additionally comprise a step of combining signals received by means of the first rake receiver and signals received by means of the second rake receiver.

Other features and advantages of the invention will become apparent on reading the following description of embodiments of the invention, which is given by way of example and with reference to the drawings, in which:

FIG. 1 is a graph of signals received by a terminal;

FIG. 2 is a block diagram of one embodiment of a terminal of the invention;

FIG. 3 is a block diagram of a recombination window of one embodiment of the invention.

One embodiment of the invention proposes to use two separate rake receivers to receive copies of the same signals; in contradistinction to the proposed prior art solution, the two receivers are not used to receive different signals coming from adjacent cells in an intercellular transfer procedure. This use of two receivers has the advantage of allowing existing solutions—chipset, components—for systems with a satellite broadcast layer. It also has the advantage that the size of the recombination window can be adapted as a function of what is required, as explained below with reference to FIG. 3. In particular, this solution enables combination of signals coming from heterogeneous sources, for example signals broadcast by a satellite and signals transmitted by repeaters.

FIG. 2 is a block diagram of a terminal of one embodiment of the invention; the figure shows only the components of the terminal necessary for understanding the invention. The terminal has a receiver stage 14 which receives radio-frequency signals and converts them to lower frequencies in the manner known in the art. The terminal also includes two rake receivers 16 and 18. The first receiver has a plurality of fingers 20-1 to 20-n and a combiner 22. Each finger of the receiver demodulates a copy of the signals received and the combiner 22 combines the demodulated versions of the various signals received in accordance with the known operating principle of the rake receiver. The figure does not show either the means for applying time-delays to the various fingers of the receiver to select the copy of the signal that is demodulated or the tracking means that can be used for a finger. The second receiver has a similar structure, with fingers 24-1 to 24-n—in this example the number of fingers is exactly the same, but this is not essential—and a second combiner 26. The terminal also includes a third combiner 28 that receives the signal supplied by the first and second combiners 22 and 26 and supplies a combined signal representative of all the copies processed in the fingers of the first and second rake receivers. The figure does not show a time-delay that may be applied to the signals coming from one of the combiners 22, 26 before their combination at 28.

The prior art terminal referred to above comprises a first rake receiver and a second rake receiver; however, those receivers are used during an intercellular transfer; one of the receivers receives signals coming from one cell and the other receives signals coming from the other cell. The terminal has no combiner for combining the signals received by the two rake receivers: to the contrary, the terminal uses the signals received by one or the other of the receivers alternately, as a function of the progress of the intercellular transfer.

Also, in the proposed prior art intercellular transfer scenario, the two receivers use different codes: this is because the signals received by the terminal from one cell and from the adjacent cell are spread using different codes. Conversely, in the proposed solution, the two rake receivers use the same despreading code.

The operation of the FIG. 2 terminal is explained with reference to FIG. 3. This shows the recombination windows 30 and 32 of the two rake receivers; each window typically has a width of 10 μs, which corresponds to forty chips. A time shift 34 may be applied between the two windows and typically varies from 0 to 33 μs. The lower limit of 0 μs corresponds to the situation of adjacent recombination windows, which yields a total signal reception width ΔT of 20 μs. The upper limit of 33 μs corresponds to a value deduced from the third generation UMTS standards, to be more precise the Technical Specifications 3GPP TS 25.211 and 3GPP TS 25.922. In the scenario of an intercellular transfer at a Node B during an active connection, the user terminal receives the signals transmitted by the Nodes B of the two adjacent cells on the dedicated transport channels (DCH). The same information is transmitted by the two nodes, but with different spreading codes. The time difference between the signals transmitted by one node and the signals transmitted by the other node depends on the synchronization between the two nodes; this synchronization is effected at the level of the Node B of the new cell, on the basis of synchronization information transmitted by the terminal. The terminal transmits periodically to the network information relating to the measured difference between the signals coming from the two nodes. The time adjustment of the transmission at the level of the Node B is effected in steps of 256 chips; as a result, the maximum time shift between the signals coming from the two Nodes B is 128 chips, i.e. 33 μs. The third generation terminals conforming to the 3GPP technical specifications can therefore track with both of the rake receivers signals time-shifted by 33 μs. This explains the upper limit of 33 μs shown in FIG. 3.

Accordingly, using the chipset of third generation UMTS terminals provides a combination window extending from 20 μs to 53 μs. These values correspond to a 110 μs recombination window for each rake receiver and a time shift between the windows from 0 to 33 μs. At the minimum, for two adjacent windows, there is a conjoint window width of 20 μs; at the maximum, for windows separated by 33 μs, the total width is 1 window+33 μs+1 window, that is to say 53 μs. All possible values from 20 to 53 μs may be swept. The fact that the time shift between the recombination window of the first receiver and the recombination window of the second receiver is at least 30 μs means that a sufficient conjoint recombination window may be provided for an S-DMB system. The total width covered by the two recombination windows is advantageously at least 50 μs; this covers the receive time shifts envisaged in the S-DMB system.

The conjoint window is advantageously used to receive signals coming from multiple sources, for example from a satellite and from one or more repeaters. If the signals coming directly from the satellite and the signals coming from one or more terrestrial repeaters are of similar power—to within a few dB—the signals coming directly from the satellite are advantageously tracked on a finger 20-1 of a rake receiver 16. The other fingers of the receiver can be used to track signals arriving from the satellite via multiple paths; those signals are typically time shifted by less than 10 μs and can be tracked by the same receiver 16. The signals coming from one or more repeaters can also be tracked using the fingers of this receiver 16 if those signals are in the recombination window containing the signals coming directly from the satellite.

The second rake receiver can then be used by a terrestrial repeater outside the recombination window of the first receiver. A plurality of repeaters or a high-altitude platform can also be tracked with the fingers of the second receiver.

The two receivers can also be used with a variable time shift between the recombination windows to sweep all possible copies of signals spread with the same spectrum.

The solution of the invention therefore enables signals to be received from a telecommunication system comprising terrestrial repeaters and a complementary source (satellite or high-altitude platform). It enables use of the same chipsets and in particular the same receivers as third generation terminals.

1. A receiver for a spread-spectrum telecommunication system, the receiver including:
a first receiver (16) with at least two demodulation channels (20-1, 20-n) and a first combiner (22) receiving the demodulated signals supplied by the demodulation channels;
a second receiver (18) with at least two demodulation channels (24-1, 24-n) and a second combiner (26) receiving the demodulated signals supplied by the demodulation channels; and
a third combiner (28) receiving the signals supplied by the first and second combiners, reception by means of the first receiver and reception by means of the second receiver being effected by despreading using the same code for despreading.

2. The receiver according to claim 1, characterized in that the time difference between the recombination window of the first receiver and the recombination window of the second receiver is greater than 30 μs.

3. The receiver according to claim 1, characterized in that the recombination window of the first receiver and the recombination window of the second receiver cover a time span of at least 50 μs.

4. A telecommunication system including:
terrestrial repeaters and a complementary source;
a receiver according to claim 1.

5. A method of receiving signals coded by spectrum spreading in a telecommunication system including terrestrial repeaters and a complementary source, the method including:
providing a terminal with a first rake receiver (16) and a second rake receiver (18);
receiving at least signals (2) coming directly from the complementary source by means of the first rake receiver (16); and
receiving signals (4, 6, 8, 10) coming from at least one terrestrial repeater using the second rake receiver (18), reception by means of the first receiver and reception by means of the second receiver being effected by despreading using the same despreading code.

6. The method according to claim 1, characterized by a step of combining signals received by means of the first rake receiver (16) and signals received by means of the second rake receiver (18).
